(19) United States
(12) Patent Application Publication
(10) Pub. No.: US 2007/0108797 A1
(43) Pub. Date: May 17, 2007

(54) Automobile Door Surface Protector

(76) Inventor: Lisa Marie Burleson, Spring, TX (US)

Correspondence Address: George S. Pavlik, 22nd Floor, 120 South Riverside Plaza, Chicago, IL, 60606-3912, US

(21) Appl. No.: 11/560,572

(22) Filed: Nov. 16, 2006

Related U.S. Application Data
(60) Provisional application No. 60/737,213, filed on Nov. 16, 2005.

(51) Int. Cl. B60J 9/00

(52) U.S. Cl. 296/153

(57) ABSTRACT

A cushioned pad is provided to protect the interior and/or exterior surface around the window area of an automobile from damage caused by a dog or other type of pet that may be riding in the automobile and leaning out the window. The pad is removably affixed to the automobile in a manner which overlays the area around the base of the window such that a dog or other animal may rest its paws on the pad covering the base edge of an automobile's open window when the animal is leaning out the window. The pad serves as a buffer between the animal and/or the interior or exterior surface of the automobile and prevents the animal's nails from scratching or otherwise damaging the automobile. The Pad also provides a cushioned support for the dog's forearms when resting its front legs over the base edge of the open window.

### CROSS REFERENCE TO RELATED APPLICATION

This application claims the benefit of the filing date of U.S. Provisional Application Ser. No. 60/737,213 filed Nov. 16, 2005 entitled “Improved Automobile Door Surface Protector”. This application is incorporated herein as if set forth in its entirety here.

### FIELD OF THE INVENTION

The present invention concerns a device for protecting an automobile from being scratched or otherwise damaged by a pet leaning out of an open window. More particularly, the present invention concerns a pad having means to remain in place in and on an automobile such that when a dog or other animal is at the window of the automobile, the automobile's paint and other components around the window area are protected from scratches or other damage caused by the animal's claws, or nails.

### BACKGROUND OF THE INVENTION

This present invention relates generally to pet accessories and more specifically to a pad, preferably cushioned, that overlays the base of an automobile window opening when the window itself is lowered.

Many dog owners enjoy taking their pets along with them in their cars when running errands or going on trips. It is generally well known that when riding in an automobile, many dogs like to stick their head out the window. While there is little scholarly research to explain this curious canine behavior, many believe that it is because they simply enjoy the sensation of a brisk wind in their ears or face or because they're able to experience a myriad of smell sensations through their acute olfactory receptors. Whatever the explanation, many owners, in an effort to accommodate their dogs, will often times allow their dogs to sit in a seat adjacent to a lowered window and to partially lean out the window. Certain owners will sometimes even allow smaller types of dogs to sit on their laps in order to better position themselves in relation to the air rushing past the open window when the car is moving.

When dogs lean out of a lowered window of an automobile, they sometimes have a tendency to raise their front legs into a position in which they are resting over the base of the window such that their front paws are extending through the window opening. In this position, the dog's nails will sometimes come in contact with the molded surface around the interior of the window opening or the painted or chromed exterior surface of the automobile. When this occurs, slight movements by the dog can cause its nails to scratch the interior or exterior surface of the automobile. Since dogs are generally in an excited state when riding in an automobile, it is sometimes difficult for them to remain still. Further, the movement of the automobile poses additional difficulty in this regard, as the dog is often jostled by the normal movements of the vehicle and a dog is typically unbalanced when standing only on its rear paws in such situations (its most stable position generally being standing on all four paws simultaneously). These factors commonly cause a dog to move his front legs, so as to adjust to a more stable position, and can thus cause the dog's nails to damage the interior or exterior of the automobile.

Such damage has been known to include scratches to the painted exterior or the molded interior of the automobile or even damage to the trim or slit where the window recesses into the automobile door when lowered. Damage of this nature can be unsightly and may reduce the value of an automobile. Further, such damage may be costly to repair; especially when it reoccurs after a first repair has been made.

Accordingly, there is a need for a device which protects the surface around the door of an automobile from damage caused by dogs or other pets that lean out of the window. There is a further need that such a device be able to remain in place when the automobile is moving and that it be easily removable from the car should the driver desire to go somewhere without the dog. In addition, it would be further desirable for this device to be made out of a durable material that will not become damaged by various weather conditions such as wind, rain or the like, and that is further able to withstand harsh treatment which occasionally will arise from use in connection with an animal. Moreover, a device accomplishing these objectives must also be comprised of a material which will not cause the animal any discomfort.

As will be described in greater detail hereinafter, the present invention accomplishes these objectives, and others, by providing a protective pad that may be removably affixed to an automobile such that it overlays the base of the opening around the automobile's window. Once positioned around the base of the window opening the present invention enables, a dog or other animal riding in the automobile to comfortably rest its arms or paws over the pad such that they are not in direct contact with the interior or exterior surface of automobile. It is intended that use of the present invention in this manner will reduce or eliminate any unintentional damage caused by the animal to the interior or exterior surface of the automobile.

### SUMMARY OF THE INVENTION

In accordance with the present invention and in order to prevent damage to a vehicle's paint by a dog's nails, an appropriately sized and cushioned automobile surface protector is provided for use around the window area of an automobile. The protector features a protective padded portion and an elongated strap, such that the protective padded portion can be placed in and through an open automobile window and hung partially out of the window while being held within the automobile by the elongated strap that extends from the pad. The elongated strap, in a preferred embodiment is provided with means to fit within a door pull strap or handle, found in most automobiles, and lock onto itself, thereby holding the pad from falling out of the automobile. In one embodiment, the protective pad includes magnets advantageously placed to better hold the pad against the outside panel of the automobile door. Preferably, the magnets are of sufficient strength to hold the pad in place while not causing any damage to the door panel or paint. Further, the magnets can be located within a portion of the pad such that a layer of cloth of the pad, or other protective substance, lies between the magnet and the automobile surface.

In one embodiment of the present invention, different protective pads are available to accommodate any brand, make and model of automobile and to accommodate different sized animals. Such variations as size of pad, to accommodate window size opening, and length of elongated strap, to accommodate the distance between the handle/strap of particular vehicles and the window opening are provided. In another embodiment, a protective pad kit is provided, that includes a protective pad having the elongated strap, as described above, and a supplemental strap that can be added to the elongated strap to increase the length of the strap, thereby allowing its use on different vehicles, and particularly different size vehicles. It will be understood by persons having ordinary skill in the art that supplemental straps, intended for use with the device of the present invention, can be sold separately without departing from the novel scope of the present invention. Separate straps would allow a person changing vehicles to continue to use an original protective pad while purchasing the necessary strap adjuster.

In a preferred embodiment the elongated strap includes portions of hook and loop fasteners, such as Velcro® brand fasteners. In the use of the protective pad and elongated strap, the user can place the protective pad portion in its appropriate position on the automobile while the elongated strap is fed through the automobile handle and folded back to be joined together about the handle. In this manner the protective pad is secured to the vehicle handle. It will be understood by persons having ordinary skill in the art that any type of fastening means or fasteners, including a buckle, clip, snaps, magnets or other types of means to fasten the strap, can be used in this manner, without departing from the novel scope of the present invention.

### BRIEF DESCRIPTION OF THE DRAWINGS

FIG. 1A is a perspective view of one embodiment of the automobile door surface protector of the present invention, having an elongated strap in an extended position.

FIG. 1B is a perspective view of the embodiment of FIG. 1A of the automobile door surface protector of the present invention, with the elongated strap fastened to itself to form a loop.

FIG. 2 is a perspective view of the automobile door surface protector of the present invention in place and fastened to the interior surface of an automobile door.

FIG. 3 is a second perspective view of the automobile door surface protector of FIG. 2 shown from the exterior of an automobile with a dog in position at the door.

FIG. 4 is a perspective view of another embodiment of the automobile door surface protector of the present invention, having a supplemental elongated strap fastened to the primary strap to form a loop.

FIG. 5 is a perspective view of the automobile door surface protector of the present invention having a supplemental elongated strap fastened to the interior surface of an automobile door.

FIG. 6 is a perspective view of another embodiment of the automobile door surface protector of the present invention, having at least one pocket on the front side, magnets within the door surface protector (shown in phantom), and an elongated strap with an alternate attachment means.

FIG. 6A is a close-up view of the strap of the present invention having an alternate attachment means.

FIG. 7 is an end view of a vehicle door showing an alternative fastening arrangement for securing the door surface protector of the present invention to the vehicle.

### DETAILED DESCRIPTION OF THE DRAWINGS

While the present invention is susceptible of embodiment in various forms, there is shown in the drawings a number of presently preferred embodiments. It should be understood that the present disclosure is to be considered as an exemplification of the present invention, and is not intended to limit the invention to the specific embodiments illustrated. It should be further understood that the title of this section of this application (“Detailed Description of the Drawings”) relates to a requirement of the United States Patent Office, and should not be found to limit the subject matter disclosed herein.

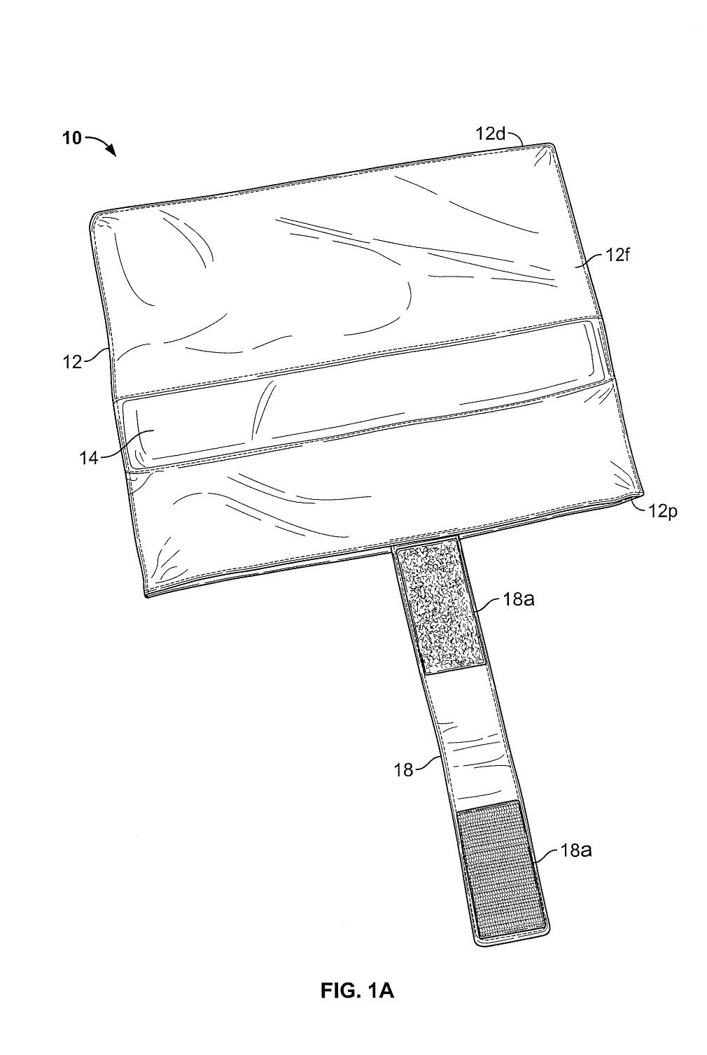

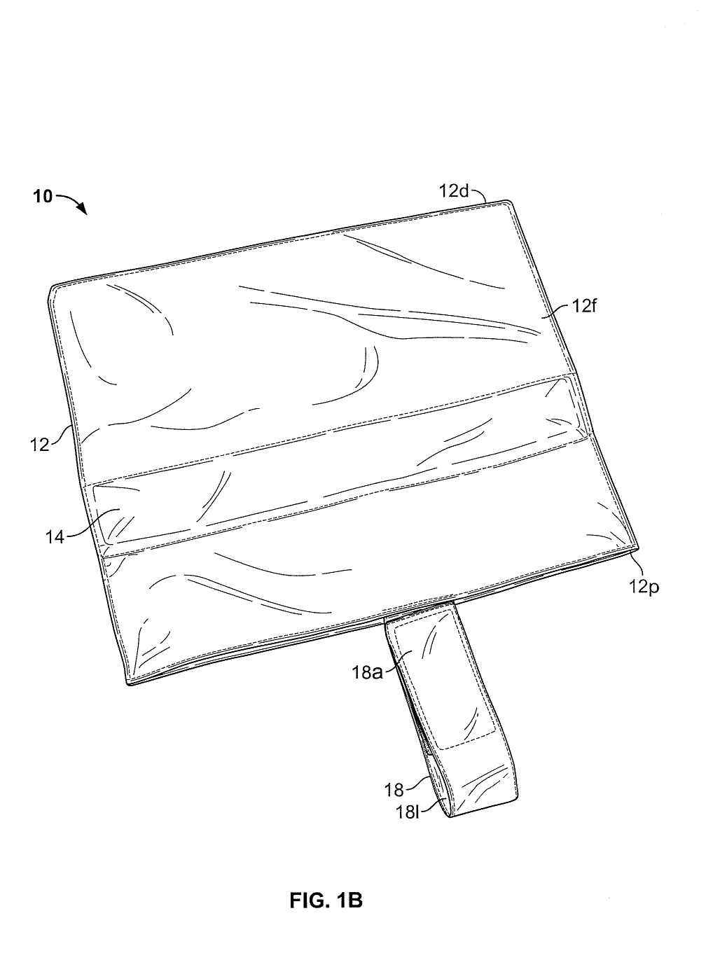

Referring now to the enclosed figures, FIG. 1A shows one embodiment of the automobile door surface protector 10 of the present invention. In the present embodiment, the protector 10 features a protective pad portion 12, having a front side 12f and back side 12b, and a proximal end 12p and a distal end 12d. As shown in FIG. 1A, the protective pad 10 can additionally feature an area 14 of additional cushioning materials between the proximal and distal ends. The additional cushioning area 14 can extend in a direction substantially parallel to the proximal and distal ends (12p, 12d) of the pad and is intended to cover the base 16b of the window opening 16 when the protector 10 is placed into a desirable use position, as shown in FIG. 1A. It will be understood by persons having ordinary skill in the art, that other means of providing padding to this portion of the protector 10, including fully padding the entire protector 10 or a larger portion of the protector than shown by strip 14, can be employed without departing from the novel scope of the present invention. It will also be understood that such padding can be included as a separate pad to be attached, with any manner of fastening means (such as hook and eye fasteners), such that the pad can be moved to accommodate differently sized vehicles, without departing from the novel scope of the present invention.

Referring again to FIGS. 1A and 1B, it will be seen that protector 10, of the present embodiment, further features an elongated holding strap 18 extending from the proximal end 12p of the pad portion 12. While the strap 18 in FIG. 1A is shown in an extended position, it features an attachment means 18a such that a loop 181 can be formed therewith, so as to attach the protector 10 to a vehicle in a manner to be discussed below. It will be understood that in fastening strap 18 the user will form a loop 181 by threading the elongated strap 18 through a vehicle orifice, such as a handle or handhold, and folding the strap 18 back onto itself. Parts of the strap will be provided with cooperative attachment or fastening means 18, such as hook and eye fasteners, to permit fastening of the protector 10, by its strap 18, to the vehicle. It will be understood by persons having ordinary skill in the art that the strap can be of different lengths and be comprised of a variety of different fabrics or other materials including but not limited to nylon, polyester, rope, rubber and numerous others, without departing from the scope of the present invention.

FIG. 1B shows the automobile door protector 10 of FIG. 1A with the attachment or fastening means 18a of the elongated strap 18 fastened to form a loop 181. When the protector 10 is positioned near the base 16b of an automobile window 16, it is intended that the loop 181 formed by the elongated strap 18 fasten around a component 24 on the interior of the vehicle, such as for example, a handle or strap on the interior surface of the door. While the attachment or fastening means 18a illustrated in FIG. 1b is shown to be a Velco® brand fastener, it will be understood that any type of fastening means or fasteners of a type conducive to this manner of fastening, including but not limited to buckle and strap, clips, snaps, buttons, or magnets can be used without departing from the novel scope of the present invention.

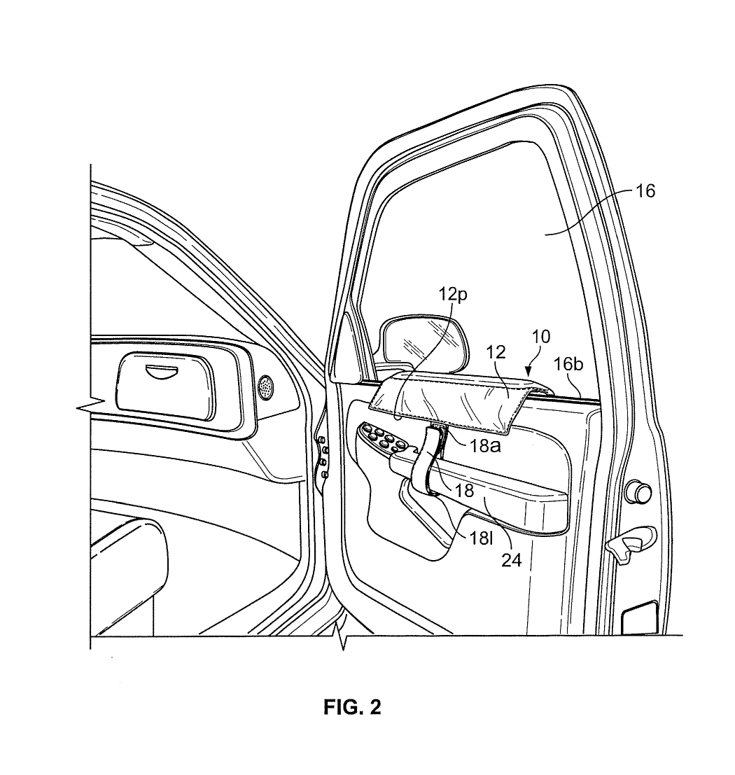

FIG. 2 illustrates one embodiment of the present invention positioned on an automobile. As shown in FIG. 2, it is intended that the protective pad 10 be used when the window 16 of the automobile is in a fully-lowered position, such that the pad portion 12 can be placed over the window opening 16b such that the proximal end 12p of the pad is inside the automobile and the distal end 12d of the pad is situated so as to cover a portion of an exterior panel of the vehicle. In this position, both the interior and exterior surfaces of the vehicle in proximity to the window area are covered and thus protected from damage that can be caused by a dog, or other animal, that may be at the window with its paws extended over the window opening. Since not all automobiles have the same sized windows, it will be understood by those having skill in the art that the protective pad 12 of the present invention can be made in a variety of different sizes and/or shapes to accommodate the window areas of different vehicle makes or models. Further, while the proximal and distal ends of the protective pad illustrated in FIG. 2 are shown to extend a particular distance past the window opening, it will be understood that the ends of the pad 12d and 12p may be made to cover more or less of the interior or exterior surface around the opening, without departing from the scope of the invention. It will be understood that this can be accomplished by providing different sized pads to cover preferences of buyers and by using different length straps 18, such that the pad 12 is positioned where desired in the automobile.

Referring now to FIG. 2, it will be seen that the elongated strap 18 of the present invention is fastened to the interior of the automobile in a manner that keeps the pad 12 held in position in the window opening when the vehicle is either moving or stopped. As shown, the elongated strap 18 in this embodiment extends from the proximal end of the pad 12 and is wrapped around a handle or strap 24 of the vehicle, within close proximity to the window opening. FIG. 2 further shows the strap 18 of the protector 10 fastened to itself via the attachment or fastening means 18a to form a loop 181 that is wrapped around, for example, the handle 24 on the door of the vehicle. The present invention contemplates that in one embodiment, straps of the protector 10 be made of various lengths in order to engage any number of different components within the interior of the vehicle in a manner such that the device of the present invention will not interfere with safe operation of the vehicle. In embodiments of the present invention, a single male fastening means can be mated with any number of female fastening means to permit various lengths for fastening a single strap. For example, a single button can be included near the proximal end of a strap with several button holes formed in the body of the strap, such that an appropriate hole can be selected for fastening. Similarly, a single hook fastener can be provided with one or more eye fasteners, or a single eye fastener of elongated length, such that adjustment can be made to the length of the strap l8 as needed.

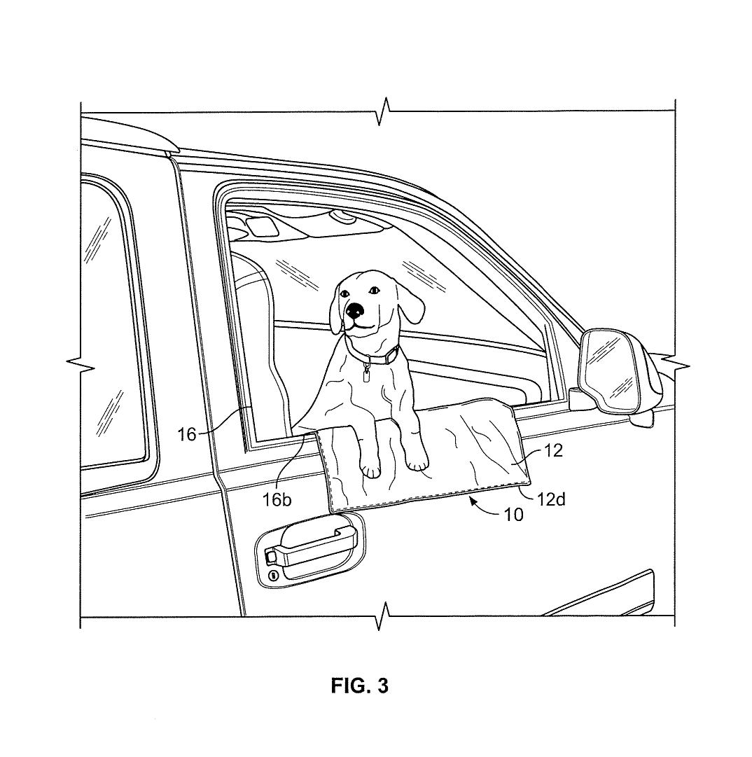

Referring now to FIG. 3, it will be seen that the exterior of an automobile, having a dog positioned at window, is shown. As shown in this figure, the dog is positioned, within the vehicle, adjacent to a lowered window such that the dog's front legs are extending over the window opening 16b and are adjacent to the exterior of the vehicle. In this arrangement, it will be seen that the pad 12 of the present invention covers the interior and exterior surfaces around the window opening 16b and thereby serves as a buffer between the dog and the vehicle. The interior and exterior surfaces of the vehicle adjacent the window, are thus protected from scratches or other damage that can be inflicted by the dog's front legs, paws or nails should the dog or car suddenly move, turn or stop. It will be understood that the pad shown is only illustrative and that the device of the present invention can be made larger or smaller, longer or shorter, and with a longer or shorter strap, to accommodate any dog as well as any size car; and all cars and dogs therebetween, without departing from the novel scope of the present invention. Further, it will be understood that the present invention can be used with any type of animal that can be transported by vehicle in the manner shown, without departing from the novel scope of the present invention.

While not specifically shown in the illustrative embodiments, the protective pad 12 of the present invention can be comprised of a variety of different durable materials in order to withstand severe weather conditions such as rain or snow or harsh treatment from use in connection with a dog. The front side of the protective pad may additionally feature a variety of different styles, designs or colors in order to satisfy the tastes of the driver or to match the colors of the vehicle in which it is used. Further, organizations can adopt such pads for sale or as gifts to members including the name of the organization or its trademark or identifying colors. The distal end of the front side of the pad may also feature emblems, labels or marks of associations, sports teams, universities or businesses according to the driver's tastes.

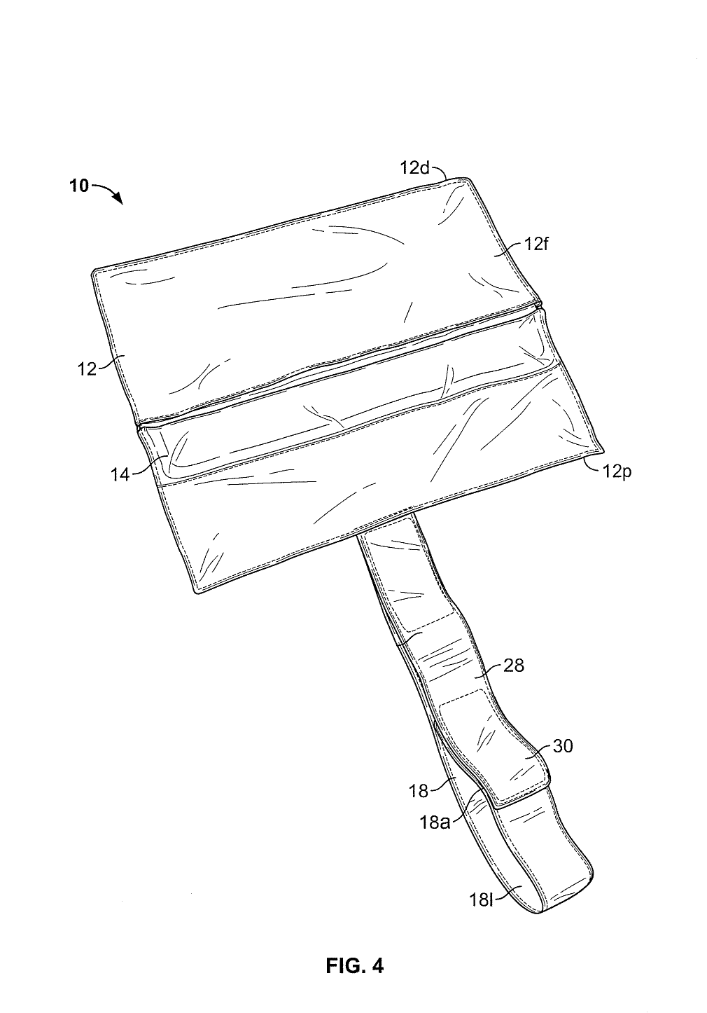

Referring now to FIG. 4, another embodiment of the present invention, having a supplemental elongated strap 28 fastened to the primary strap 18 to form a loop 181, is shown. In this embodiment, the supplemental strap 28 has an attachment means 30 complementary to the attachment means 18a of the primary strap 18 and can thus be readily fastened to the primary strap 18 in order to increase the length of the strap and/or the circumference of the loop formed thereby. Like the primary strap 18, the supplemental strap 28 of the present invention can be made of various materials and can be of various lengths. In addition, while only one supplemental strap 28 is shown in FIG. 4, it is contemplated that the protector 10 of the present invention can be used with multiple supplemental straps 28 to enlarge the length of the loop even further as needed or desired.

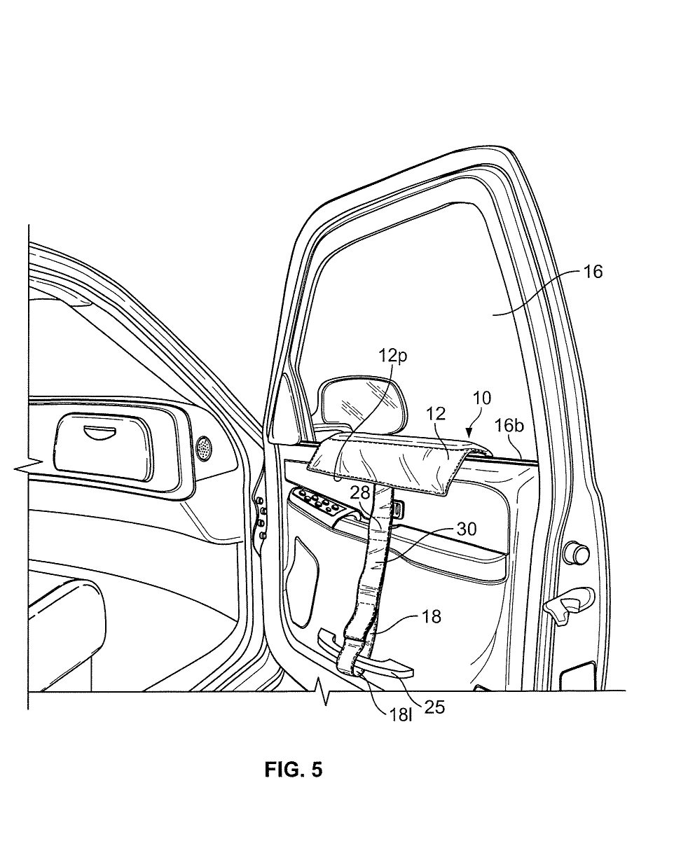

The supplemental strap 28 enables the present invention to be fastened to fixed components 25 within the interior of the vehicle that are at a greater distance from the window opening 16b; and also enables a single protector 10 to be used in different types of vehicles (that is those having larger proportions). Accordingly, it will be understood that supplemental straps 28 for use with the present invention may be sold as separate accessories from the protector without departing from novel scope of the present invention. In this way, those having no need for an additional strap need only buy the protector 10. Alternatively, the protector 10 of the present invention and one or more supplemental straps can be sold together as a kit such that the user can change vehicles, such as in situation where one family has more than one vehicle, and continue to use the original protector 10 with the necessary number of supplemental straps to fit the second or other vehicle. FIG. 5 shows another embodiment of the present invention coupled to the interior of an automobile door (the door is shown open for ease of viewing). In this embodiment, the protector 10 is shown in connection with a supplemental elongated strap 28 which together with the primary strap 18 forms a loop 181 that is engaged with a handle or strap 25 in the interior of the vehicle. By engaging the interior of the vehicle in this manner, the protector 10 is secured in place within the window opening 16b. Since the loop 181 formed by the primary and supplemental strap (18, 28) forms a loop 181 with a larger circumference, the protector 10 is able to fasten to interior vehicle components that are a greater distance away from the window opening 16b.

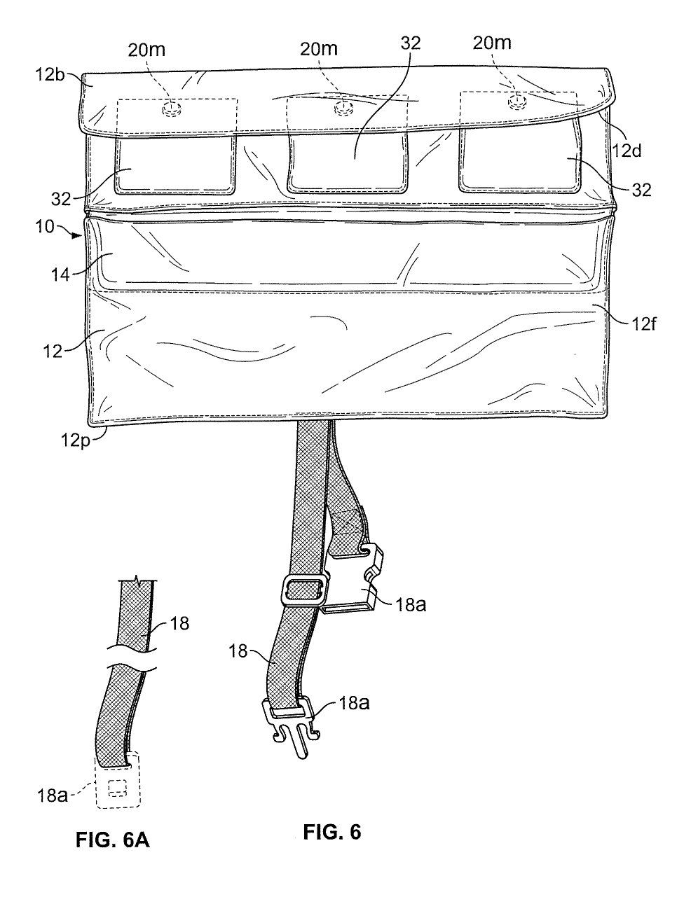

An alternate embodiment of the present invention is shown in FIG. 6. In this embodiment, at least one pocket 32 is disposed within the front side 12f of the protective pad 12 near to the distal end of the pad 12. When the pad 12 is placed into position in the window opening 16b, the one or more pocket 32 can be positioned over the exterior surface of the vehicle such that they can be accessed even if a dog is at the window of the vehicle and in a position over the pad. As shown in FIG. 6, the invention may also feature at least one magnet 20m positioned in a location near to or at the distal end of the protective pad 12. In this embodiment when the pad 12 is placed into position in the window opening, the magnets 20m will be positioned over the exterior surface of the vehicle and can assist in securing the pad 12 over the window opening by magnetic attraction to the metal alloy of the vehicle's exterior surface. The magnet(s) 20m thus provide additional support for holding the pad in place while the vehicle is moving or stopped with or without the dog in position. The magnet(s) 20m of the present invention may be arranged in various configurations and may be fastened to the bottom surface of the pad 12b or may be disposed within the pad between the front and back sides. Alternatively, the magnets 20m can be placed within the pockets 32 of the protector 10 such that they can be easily removed in order to wash the protector 10, or in the event that their use is not desired with respect to a particular situation. No matter what position they are located on the protector, the magnet(s) 20m will be of sufficient strength to hold the pad 12 in place while not causing any damage to the exterior surface or paint of the vehicle. It will be understood by persons having ordinary skill in the art that while magnets will have no magnetic effect on vehicles made of fiberglass, plastics or other non-metallic materials, the weight of the magnets 20m will also assist in maintaining the protector 10 of the present invention in position at the window.

It will be understood that a vehicle can be created having means for connection of a strap 18 of the present invention to a built in holding device. For example, persons having skill in the art will recognize that baby seats are now attachable via anchor means built into modern automobiles. The device of the present invention can incorporate any type of cooperative anchor attachment device, such that the attachment is made simply to such built-in anchors, without departing from the novel scope of the present invention; an example of such an embodiment is illustrated in FIG. 6A. As shown in FIG. 6A, the strap 18 may have an attachment means 18a which is adapted to fasten to an attachment point inside the vehicle such as a seat belt clip or child safety device. The attachment means 18a accordingly may be sized or shaped to engage any type of clip or restraining member. In this embodiment, the strap 18 can include means to elongate the strap, such as simple friction fit buckles and straps, such as those used in child safety devices. These devices will have the added benefit of providing a more finished, made for the vehicle look as well as giving added strength to the connection.

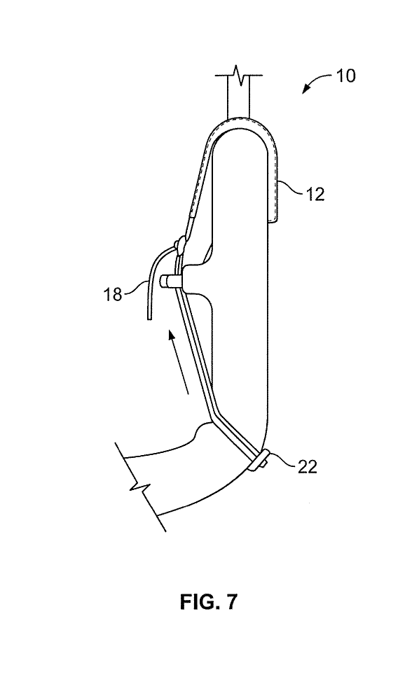

Referring now to FIG. 7, an additional embodiment of the present invention is shown. In this embodiment, the strap 18 of the protector 10 is of sufficient length to extend past the bottom of the door of the vehicle such that when the door is closed, the strap will extend outside the vehicle through the bottom of the closed door. The driver can then pull the strap 18 in order to securely fasten the protector to the vehicle. The end of the strap 18 extending past the bottom of the door has an enlarged portion 22 which acts as a stopper to prevent the strap from slipping under the closed door and inside the vehicle when the driver tightens the strap 18. The enlarged portion 22 of the strap in this embodiment can be formed by the strap 18 itself, such as with a knot or by being folded over itself and stitched, or in the alternative, may be a formed by a member fastened to the strap 18. This alternative fastening arrangement enables the protector 10 to be secured to the vehicle where there is no bar or handle on the interior of the vehicle for the strap 18 of the protector 10 to fasten around.

The present disclosure includes that which is contained in the appended claims, as well as that of the forgoing description. Although, this invention has been described in its preferred form with a certain degree of particularity, it is understood that the present disclosure of the preferred form has been made only by way of example, and that numerous changes in the details of the elements, compositions and the combination of individual ingredients may be resorted to without departing from the novel spirit or scope of the invention.

What is claimed is:

1. An automobile surface protector for use in a vehicle having an open window, comprising:
a pad having a proximal and distal end;
an elongated strap, extending from the proximal end of the pad, the strap having attachment means for fastening the protector to an appropriate anchor point inside of a vehicle;
the strap being of sufficient length so that when it is attached to the anchor point in the vehicle, the distal end of the pad extends outside of the vehicle at the open window.

2. The surface protector of claim 1 further comprising at least one magnet on the back side of the protective pad near to the distal end of the pad.

3. The surface protector of claim 1 further comprising at least one pocket formed in the front side of the protective pad near to the distal end of the pad.

4. The surface protector of claim 1 wherein the protective pad further comprises an area of additional cushioning between its proximal and distal ends, the area extending in a direction substantially parallel to the perimeters of the proximal and distal ends of the pad.

5. The surface protector of claim 1 further comprising an elongated supplemental strap having a complementary attachment means to the primary strap, the supplemental strap adapted to fasten to the primary strap to extend the length of the strap.

6. The automobile surface protector of claim 1 wherein the elongated strap is adapted to form a loop such that the strap can be folded back and fastened to itself by an attachment means, thereby anchoring the pad within the vehicle; the strap being of sufficient length so that when it is attached to the anchor point in the vehicle, the distal end of the pad extends outside of the vehicle at the open window.

7. The surface protector of claim 6 wherein the attachment means of the elongated strap are hook and eye fasteners.

8. The surface protector of claim 6 wherein the attachment means of the elongated strap are a buckle and cooperative buckle openings.

9. The surface protector of claim 6 wherein the attachment means of the elongated strap are at least one pair of snap elements.

10. The surface protector of claim 6 wherein the attachment means of the elongated strap are at least one magnet and a cooperative metallic anchor.

11. The surface protector of claim 6 wherein the attachment means of the elongated strap are at least one button and cooperative button holes.

12. A kit for protecting an automobile surface adjacent to a window, the kit comprising:
a protective pad having a proximal end and a distal end;
an elongated primary strap extending from the proximal end of the protective pad, the strap having an attachment means for fastening to an anchor point in a vehicle; and
an elongated supplemental strap having a complementary attachment means to the primary strap, the supplemental strap adapted to fasten to the primary strap so as to extend the length of the strap.

13. The kit of claim 11 further comprising at least one magnet within the protective pad near to the distal end of the pad.

14. The kit of claim 11 further comprising at least one pocket formed in the protective pad near to the distal end of the pad.

15. The kit of claim 11 wherein the protective pad further comprises an area of additional cushioning formed between the proximal and distal ends of the pad, the area extending in a direction substantially parallel to the perimeters of the proximal and distal ends of the pad.

16. A device for protecting an automobile surface adjacent to a window, the device comprising:
a protective pad having a front and back side and a proximal and distal end, the pad having at least one magnet on the back side of the protective pad near to the distal end of the pad and further having at least one pocket embedded in the front side of the protective pad near to the distal end of the pad, the pad also having an area of additional cushioning between the proximal and distal ends, the area extending in a direction substantially parallel to the perimeters of the proximal and distal ends of the pad;
an elongated primary strap extending from the proximal end of the protective pad, the strap having an attachment means for fastening onto itself to form a loop, the loop adapted to wrap around an interior handle or strap of the automobile; and
an elongated supplemental strap having a complementary attachment means as the primary strap, the supplemental strap adapted to fasten to the primary strap to extend the length of the strap.

17. The surface protector of claim 16 wherein the attachment means of the primary and supplemental straps are hook and loop fasteners.

18. The surface protector of claim 16 wherein the attachment means of the primary and supplemental straps is a clip.

19. The surface protector of claim 16 wherein the attachment means of the primary and supplemental straps are at least one pair of snap elements.

20. The surface protector of claim 16 wherein the attachment means of the primary and supplemental straps are at least one magnet and a cooperative metallic anchor.

21. The surface protector of claim 16 wherein the attachment means of the primary and supplemental straps are at least one button and cooperative button holes.
